(19) United States
(12) Patent Application Publication
(10) Pub. No.: US 2026/0083059 A1
(43) Pub. Date: Mar. 26, 2026

(54) ACCUMULATOR ASSEMBLY FOR AN AGRICULTURAL HARVESTER

(71) Applicants: CNH Industrial America LLC, New Holland, PA (US); CNH Industrial Belgium N.V., Zedelgem (BE)

(72) Inventors: Jordan Beckhusen, McGregor, TX (US); Brian Patrick Crow, Andalusia, IL (US); Blake Christopher Gettig, Kerrville, TX (US); Rogelio Chovet, De Pinte (BE)

(21) Appl. No.: 18/894,247

(22) Filed: Sep. 24, 2024

(51) Int. Cl. A01D 46/08; A01D 61/00

(52) U.S. Cl. CPC A01D 46/084; A01D 61/008

(57) ABSTRACT

An accumulator assembly for an agricultural harvester includes an accumulator configured to receive agricultural product from a header of the agricultural harvester via an inlet portion of the accumulator. The accumulator includes a front wall, a rear wall, and a floor. The accumulator assembly also includes at least one auger disposed within the accumulator and extending laterally across the accumulator. Furthermore, the accumulator assembly includes multiple conveying rollers positioned at a bottom of the accumulator, in which the conveying rollers are configured to convey the agricultural product toward a conveying system. A ratio of a maximum longitudinal extent of the accumulator between the front wall and the rear wall along a longitudinal axis of the accumulator assembly to a maximum vertical extent of the accumulator between a top of the inlet portion and the floor along a vertical axis of the accumulator assembly is greater than 0.8:1.

### BACKGROUND

The present disclosure relates generally to an accumulator assembly for an agricultural harvester.

Agricultural harvesters are used to harvest agricultural products (e.g., cotton or other natural material(s)). For example, an agricultural harvester may include a header having drums configured to harvest the agricultural product from a field. The agricultural harvester may also include an air-assisted conveying system configured to move the agricultural product from the drums to an accumulator assembly. The agricultural product may then be fed into a baler via a conveying system. The baler may compress the agricultural product into a package to facilitate storage, transport, and handling of the agricultural product. For example, a round baler may compress the agricultural product into a round bale within a baling chamber, such that the round bale has a desired size and density. After forming the bale, the bale may be wrapped with a bale wrap to secure the agricultural product within the bale and to generally maintain the shape of the bale.

### BRIEF DESCRIPTION

In certain embodiments, an accumulator assembly for an agricultural harvester includes an accumulator configured to receive agricultural product from a header of the agricultural harvester via an inlet portion of the accumulator. The accumulator includes a front wall, a rear wall, and a floor. The accumulator assembly also includes at least one auger disposed within the accumulator and extending laterally across the accumulator. Furthermore, the accumulator assembly includes multiple conveying rollers positioned at a bottom of the accumulator, in which the conveying rollers are configured to convey the agricultural product toward a conveying system. A ratio of a maximum longitudinal extent of the accumulator between the front wall and the rear wall along a longitudinal axis of the accumulator assembly to a maximum vertical extent of the accumulator between a top of the inlet portion and the floor along a vertical axis of the accumulator assembly is greater than 0.8:1.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of an agricultural machine system having an agricultural product transport assembly and a baler;

FIG. 2 is a schematic view of an embodiment of an agricultural product transport assembly and an embodiment of a baler that may be employed within the agricultural machine system of FIG. 1;

FIG. 3 is a cross-sectional side view of an embodiment of an accumulator assembly that may be employed within the agricultural product transport assembly of FIG. 2;

FIG. 4 is a cross-sectional front view of the accumulator assembly of FIG. 3; and

FIG. 5 is a cross-sectional side view of another embodiment of an accumulator assembly that may be employed within the agricultural product transport assembly of FIG. 2.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

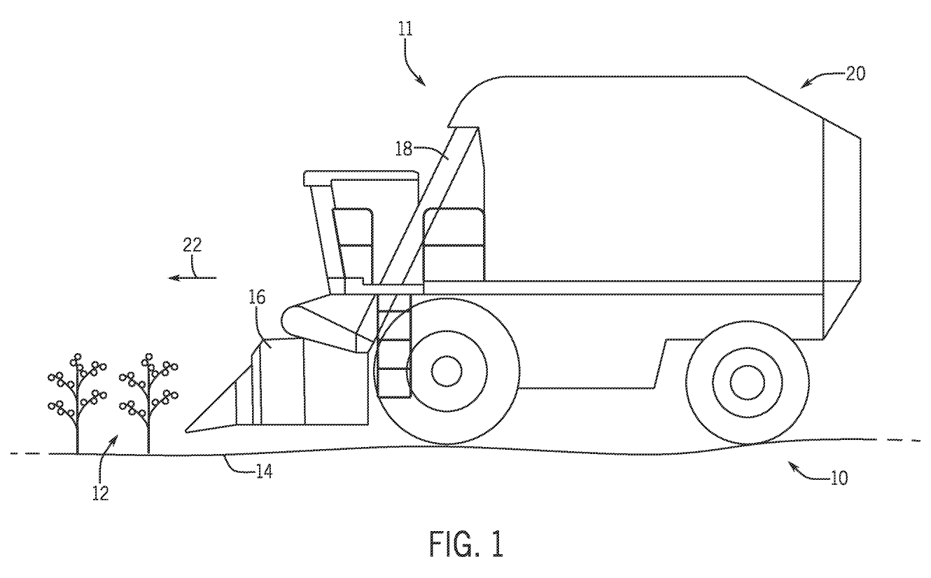

FIG. 1 is a side view of an embodiment of an agricultural machine system 10 (e.g., harvester, agricultural harvester) having an agricultural product transport assembly 11 and a baler. The agricultural machine system 10 is configured to harvest agricultural product 12 (e.g., cotton) from a field 14 and to form the agricultural product 12 into bales (e.g., agricultural bales). In the illustrated embodiment, the agricultural machine system 10 includes a header 16 having drums configured to harvest the agricultural product 12 from the field 14. Additionally, the agricultural product transport assembly 11 of the agricultural machine system 10 includes an air-assisted conveying system 18 configured to move the agricultural product 12 from the drums of the header 16 to an accumulator assembly of the agricultural product transport assembly 11. The agricultural product transport assembly 11 also includes a conveying system configured to convey the agricultural product 12 from the accumulator assembly into the baler 20 (e.g., agricultural baler). The baler 20 is supported by and/or mounted within or on a chassis of the agricultural machine system 10. The baler 20 may form the agricultural product 12 into round bales. However, in other embodiments, the baler 20 of the agricultural machine system 10 may form the agricultural product into square bales, polygonal bales, or bales of other suitable shape(s). After forming the agricultural product 12 into a bale, a bale wrapping system of the agricultural machine system 10 wraps the bale with a bale wrap to secure the agricultural product 12 within the bale and to generally maintain a shape of the bale.

In certain embodiments, the accumulator assembly includes an accumulator configured to receive the agricultural product 12 from the header 16 of the agricultural machine system 10 via an inlet portion of the accumulator. The accumulator includes a front wall, a rear wall, and a floor. In addition, the accumulator assembly includes at least one auger disposed within the accumulator and extending laterally across the accumulator. The accumulator assembly also includes multiple conveying rollers positioned at a bottom of the accumulator. The conveying rollers are configured to convey the agricultural product toward the conveying system. Furthermore, a ratio of a maximum longitudinal extent of the accumulator between the front wall and the rear wall along a longitudinal axis of the accumulator assembly to a maximum vertical extent of the accumulator between a top of the inlet portion and the floor along a vertical axis of the accumulator assembly is greater than 0.8:1. As a result, the maximum vertical extent of the accumulator may be sufficiently reduced to enable the agricultural machine system 10 to be certified for on-road use (e.g., as compared to an accumulator having a smaller maximum longitudinal extent and the same capacity). Furthermore, the reduced maximum vertical extent of the accumulator may reduce the pressure applied by the agricultural product to the conveying rollers, thereby reducing the power utilized to drive the conveying rollers to rotate. As a result, the efficiency of the agricultural machine system may be increased.

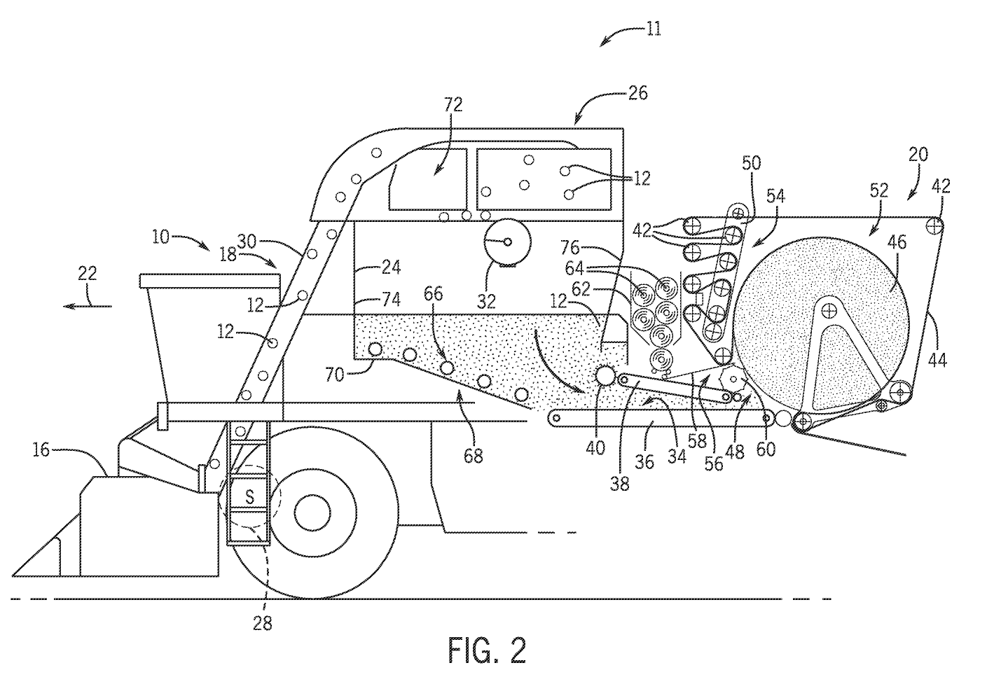

FIG. 2 is a schematic view of an embodiment of an agricultural product transport assembly 11 and an embodiment of a baler 20 that may be employed within the agricultural machine system 10 of FIG. 1. As previously discussed, the header 16 of the agricultural machine system 10 includes drums configured to harvest the agricultural product 12 (e.g., cotton) from the field. Furthermore, the air-assisted conveying system 18 is configured to move the agricultural product 12 from the drums of the header 16 to an accumulator 24 of the accumulator assembly 26. In the illustrated embodiment, the air-assisted conveying system 18 includes a conveying air source 28 configured to output a conveying air flow through one or more ducts 30. Each duct 30 receives the agricultural product 12 (e.g., cotton) from the header 16, and the conveying air flow output by the conveying air source 28 drives the agricultural product to move through the duct(s) 30 from the header 16 to the accumulator 24 of the accumulator assembly 26.

In the illustrated embodiment, the accumulator assembly 26 includes an auger 32 extending laterally across the accumulator 24 (e.g., crosswise to the downward movement of the agricultural product 12 through the accumulator 24). The auger 32 is configured to control distribution of the agricultural product 12 (e.g., cotton) within the accumulator 24 and to move the agricultural product 12 downwardly (e.g., to facilitate movement of the agricultural product 12 toward the conveying system 34). In the illustrated embodiment, the accumulator assembly 26 includes a single auger 32, which is the only auger disposed within the accumulator 24. However, in other embodiments, the accumulator assembly may include more or fewer augers (e.g., 0, 2, 3, 4, or more). For example, in certain embodiments, the auger may be omitted.

In the illustrated embodiment, the conveying system 34 (e.g., feeding system) of the agricultural product transport system 11 includes a first belt (e.g., belt) 36 configured to move the agricultural product 12 from the accumulator 24 to the baler 20. The first belt 36 is configured to rotate in a first rotational direction to move an agricultural product engaging surface of the first belt 36 toward the baler 20. Furthermore, in the illustrated embodiment, the conveying system 34 includes a second belt 38 positioned on an opposite side of the agricultural product 12 from the first belt 36, and the second belt 38 is configured to cooperate with the first belt 36 to move the agricultural product 12 from the accumulator 24 to the baler 20. Furthermore, in the illustrated embodiment, the conveying system 34 includes an agitation roller 40 (e.g., beater roller) positioned upstream of the second belt 38. The agitation roller 40 is configured to agitate the agricultural product 12 entering the pair of opposing belts, thereby enhancing the uniformity of the distribution of the agricultural product passing through the pair of opposing belts. While the conveying system 34 includes one agitation roller 40 in the illustrated embodiment, in other embodiments, the conveying system may include two or more agitation rollers, or the agitation roller may be omitted.

In the illustrated embodiment, the baler 20 includes multiple rollers 42 that support and/or drive rotation of one or more belts 44. For example, one or more rollers 42 engage the belt(s) 44, which enable the belt(s) 44 to move along the pathway defined by the rollers 42 and the bale 46. One or more rollers 42 are driven to rotate via a belt drive system (e.g., including electric motor(s), hydraulic motor(s), pneumatic motor(s), etc.). The belt(s) 44 circulate around the pathway defined by the rollers 42 and the bale 46. Movement of the belt(s) 44 captures agricultural product 12 from the conveying system 34 and draws the agricultural product 12 into a cavity 48, where the agricultural product 12 is gradually built up to form the bale 46.

In the illustrated embodiment, the baler 20 includes a tension arm 50 (e.g., take-up assembly) configured to establish tension within the belt(s) 44. As the agricultural product 12 builds within the cavity 48, the agricultural product 12 applies a force to the belt(s) 44 that urges a first portion 52 of the belt(s) 44 surrounding the bale 46 to expand. Concurrently, the size of a second portion 54 (e.g., serpentine portion) of the belt(s) 44 is reduced. Accordingly, the second portion 54 of the belt(s) 44 provides the increasing belt length for the expanding first portion 52. In the illustrated embodiment, the second portion 54 of the belt(s) 44 is established by fixed rollers 42 (e.g., rollers fixed to a housing/frame of the baler 20) and rollers 42 coupled to the tension arm 50, which is pivotable relative to the fixed rollers 42 (e.g., relative to the housing/frame of the baler 20). Accordingly, as the agricultural product 12 builds within the cavity 48, the tension arm 50 is driven to rotate, thereby reducing the size of the second portion 54 and enabling the first portion 52 to expand.

Once the bale 46 reaches a desired size, a bale wrapping system 56 wraps the bale 46 with a bale wrap 58 to secure the agricultural product within the bale 46 and to generally maintain a shape of the bale 46, such as the round shape in the illustrated embodiment. In other embodiments, the shape of the bale may be rectangular, polygonal, or another suitable shape. The bale wrap 58 may be fed into contact with the bale 46 using one or more feed rollers. The feed rollers drive the bale wrap 58 toward a starter roller 60 (e.g., which is configured to initiate formation of the core of the bale 46). The starter roller 60 is configured to rotate to drive the bale wrap 58 into contact with the bale 46. The bale wrap 58 is captured between the bale 46 and the belt(s) 44. Accordingly, rotation of the bale 46 draws the bale wrap 58 around the bale 46, thereby wrapping the bale 46. After the bale 46 is wrapped, the bale 46 is ejected from the baler 20, and the process of forming a subsequent bale may be initiated.

In certain embodiments, during the harvesting process, the conveying system 34 and the baler 20 may be periodically activated to transfer the agricultural product 12 from the accumulator 24 to the baler 20 and to form the bale 46. For example, as the agricultural machine system 10 traverses a field, the agricultural product 12 may accumulate within the accumulator 24 (e.g., during an accumulator filling process). After a selected duration, the conveying system 34 may be activated to transfer the agricultural product 12 from the accumulator 24 to the baler 20 (e.g., during an accumulator unloading process). For example, the conveying system 34 may move the agricultural product 12 toward the baler 20 at a significantly faster rate than the air-assisted conveying system 18 moves the agricultural product 12 into the accumulator 24. Concurrently with activation of the conveying system 34, the baler 20 may be activated to initiate the bale forming process, as described above. After another selected duration, the conveying system 34 and the baler 20 may be deactivated to enable the accumulator 24 to collect additional agricultural product 12. In certain embodiments, the conveying system 34 and the baler 20 may be activated four or five times to enable the bale 46 to reach the desired size. As previously discussed, once the bale reaches the desired size, the bale wrapping system 56 wraps the bale 46 with the bale wrap 58. Because the conveying system 34 and the baler 20 are periodically activated, the agricultural machine system 10 may utilize less energy during the harvesting process (e.g., as compared to continuously operating the conveying system and the baler).

In the illustrated embodiment, the agricultural machine system 10 includes a bale wrap assembly storage compartment 62 configured to store multiple bale wrap assemblies 64. In certain embodiments, each bale wrap assembly 64 includes a shaft and a bale wrap disposed about the shaft to form a roll of the bale wrap. However, in other embodiments, the shaft may be omitted, and the bale wrap may be arranged in a roll (e.g., with a hollow region at the center). The bale wrap assembly storage compartment 62 is configured to sequentially provide each bale wrap assembly 64 to the bale wrapping system 56, thereby enabling the bale wrapping system 56 to wrap the bale 46. While the agricultural machine system 10 includes the bale wrap assembly storage compartment 62 in the illustrated embodiment, in other embodiments, the bale wrap assembly storage compartment may be omitted (e.g., the bale wrapping system may store a single bale wrap assembly).

In the illustrated embodiment, the accumulator assembly 26 includes multiple conveying rollers 66 (e.g., meter rollers) positioned at a bottom 68 of the accumulator 24. The conveying rollers 66 are configured to convey the agricultural product 12 toward the conveying system 34 (e.g., toward the agitation roller 40 of the conveying system 34). In addition, the accumulator 24 includes a floor 70 having a flat portion and an angled portion. The flat portion is positioned forward of the angled portion relative to the direction of travel 22, and the angled portion is angled downwardly from the flat portion. Furthermore, the conveying rollers 66 include at least one first conveying roller positioned at the flat portion of the floor 70 with respect to a longitudinal axis of the accumulator assembly 26, and the conveying rollers 66 include at least one second conveying roller positioned at the angled portion of the floor 70 with respect to the longitudinal axis of the accumulator assembly 26. The flat portion of the floor 70 enables the capacity of the accumulator 24 to be increased, while maintaining a desired slope of the angled portion and a desired vertical extent of the accumulator (e.g., as compared to an accumulator having the desired vertical extent and a floor that only includes an angled portion at the desired slope). The increased capacity of the accumulator 24 may substantially reduce or eliminate the possibility of interrupting the harvesting operation due to overfilling the accumulator.

Furthermore, in the illustrated embodiment, the accumulator 24 includes an inlet portion 72 configured to receive the agricultural product 12 from the header 16 via the air-assisted conveying system 18. The accumulator 24 also includes a front wall 74 and a rear wall 76. A ratio of a maximum longitudinal extent of the accumulator 24 between the front wall 74 and the rear wall 76 along the longitudinal axis of the accumulator assembly 26 to a maximum vertical extent of the accumulator 24 between a top of the inlet portion 72 and the floor 70 along a vertical axis of the accumulator assembly 26 is greater than 0.8:1. As a result, the maximum vertical extent of the accumulator 24 may be sufficiently reduced to enable the agricultural machine system 10 to be certified for on-road use (e.g., as compared to an accumulator having a smaller maximum longitudinal extent and the same capacity). Furthermore, the reduced maximum vertical extent of the accumulator may reduce the pressure applied by the agricultural product to the conveying rollers 66, thereby reducing the power utilized to drive the conveying rollers 66 to rotate. As a result, the efficiency of the agricultural machine system 10 may be increased.

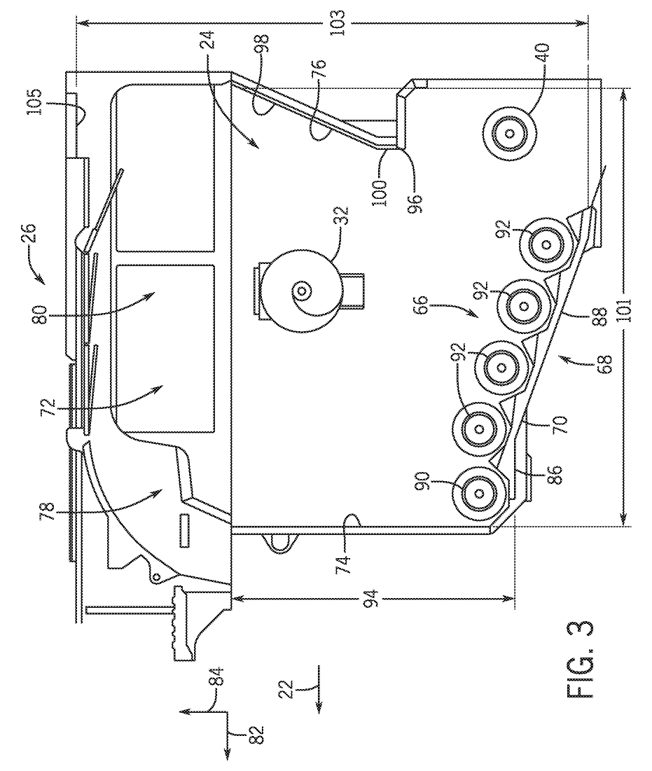

FIG. 3 is a cross-sectional side view of an embodiment of an accumulator assembly 26 that may be employed within the agricultural product transport assembly of FIG. 2. As previously discussed, the inlet portion 72 of the accumulator 24 is configured to receive the agricultural product from the header via the air-assisted conveying system. In the illustrated embodiment, the inlet portion 72 of the accumulator 24 includes one or more inlet ducts 78 configured to receive the agricultural product and to direct the agricultural product along a longitudinal extent of a distribution section 80 of the inlet portion 72 (e.g., extent of the distribution section 80 with respect to a longitudinal axis 82 of the accumulator assembly 26). From the inlet portion 72, the agricultural product moves downwardly with respect to a vertical axis 84 of the accumulator assembly 26 under the influence of gravity.

As previously discussed, the single auger 32 of the accumulator assembly 26 is disposed within the accumulator 24 and extends laterally across the accumulator 24 (e.g., with respect to a lateral axis of the accumulator assembly). The single auger 32 is configured to control distribution of the agricultural product within the accumulator 24 and to move the agricultural product downwardly with respect to the vertical axis 84 of the accumulator assembly 26. In the illustrated embodiment, the single auger 32 is the only auger disposed within the accumulator 24. Furthermore, in the illustrated embodiment, the single auger 32 is positioned closer to the rear wall 76 of the accumulator 24 than the front wall 74 of the accumulator 24 with respect to the longitudinal axis 82 of the accumulator assembly 26. A larger portion of the agricultural product may be directed toward a rearward portion of the accumulator 24 by the airflow from the air-assisted conveying system (e.g., due to the velocity of the airflow and/or the shape of the inlet duct(s) 78 of the inlet portion 72). Accordingly, positioning the single auger 32 closer to the rear wall 76 with respect to the longitudinal axis 82 may enable the single auger 32 to engage a significant portion of the agricultural product (e.g., more agricultural product than an auger positioned equidistant from the front and rear walls with respect to the longitudinal axis). As a result, the residence time of the agricultural product within the accumulator 24 (e.g., the amount of time the agricultural product resides within the accumulator) may be reduced, thereby enhancing the flow of the agricultural product to the conveying system, which may enable the capacity of the accumulator to be reduced while effectively providing the conveying system with the agricultural product. Furthermore, because the accumulator assembly 26 includes one auger 32, the agricultural product forward of the single auger 32 with respect to the direction of travel 22 may move downwardly through the accumulator 24 without interruption. As a result, the residence time of the agricultural product within the accumulator 24 may be further reduced (e.g., as compared to an accumulator assembly with multiple augers distributed along the longitudinal axis). Furthermore, the position of the single auger 32 with respect to the vertical axis 84 may be selected to facilitate access to the single auger 32 (e.g., during maintenance operations) and to provide vertical separation between the single auger 32 and agricultural product height sensor(s) within the accumulator (e.g., a minimum height sensor and/or a maximum height sensor).

While the single auger 32 is positioned closer to the rear wall 76 of the accumulator 24 than the front wall 74 of the accumulator 24 with respect to the longitudinal axis 82 of the accumulator assembly 26 in the illustrated embodiment, in other embodiments, the single auger may be positioned closer to the front wall of the accumulator than the rear wall of the accumulator with respect to the longitudinal axis of the accumulator assembly, or the single auger may be positioned equidistant from the front and rear walls of the accumulator with respect to the longitudinal axis of the accumulator assembly. Furthermore, while the accumulator assembly 24 includes the single auger 32 in the illustrated embodiment, in other embodiments, the accumulator assembly may include more or fewer augers (e.g., 0, 2, 3, 4, or more). For example, in certain embodiments, the auger may be omitted.

In the illustrated embodiment, the conveying rollers 66 are positioned at the bottom 68 of the accumulator 24. As previously discussed, the conveying rollers 66 are configured to convey the agricultural product toward the conveying system. The conveying rollers 66 may be driven to rotate via any suitable drive system(s), such as one or more electric motors, one or more hydraulic motors, etc. For example, in certain embodiments, at least a portion of the conveying rollers (e.g., all of the conveying rollers) may be rotatably coupled to one another by a belt or a chain, and one or more motors may drive the belt or the chain to rotate, thereby driving the conveying rollers to rotate. In addition, in the illustrated embodiment, the floor 70 of the accumulator 24 has a flat portion 86 and an angled portion 88. The conveying rollers 66 include at least one first conveying roller 90 positioned at the flat portion 86 of the floor 70 with respect to the longitudinal axis 82 of the accumulator assembly 26 (e.g., the center of each first conveying roller 90 is positioned at the flat portion 86 of the floor 70 with respect to the longitudinal axis 82 of the accumulator assembly 26), and the conveying rollers 66 include at least one second conveying roller 92 positioned at the angled portion 88 of the floor 70 with respect to the longitudinal axis 82 of the accumulator assembly 26 (e.g., the center of each second conveying roller 92 is positioned at the angled portion 88 of the floor 70 with respect to the longitudinal axis 82 of the accumulator assembly 26). While the conveying rollers 66 include one (e.g., only one) first conveying roller 90 (e.g., single conveying roller) in the illustrated embodiment, in other embodiments, the conveying rollers may include multiple first conveying rollers (e.g., 2, 3, 4, 5, 6, or more). Furthermore, while the conveying rollers 66 include four second conveying rollers 92 in the illustrated embodiment, in other embodiments, the conveying rollers may include more or fewer second conveying rollers (e.g., 1, 2, 3, 5, 6, or more). In addition, in the illustrated embodiment, the accumulator assembly 26 includes five conveying rollers 66 (e.g., one first conveying roller 90 and four second conveying rollers 92). Having five or more conveying rollers 66 (e.g., first conveying rollers 90, second conveying rollers 92, or a combination of first and second conveying rollers) may enhance flow of the agricultural product through the accumulator toward the conveying system (e.g., as compared to an accumulator assembly having four or fewer conveying rollers). Accordingly, in certain embodiments, the accumulator assembly may include five, six, seven, eight, or more conveying rollers. However, in other embodiments, the accumulator assembly may have four or fewer conveying rollers.

In the illustrated embodiment, the flat portion 86 is positioned forward of the angled portion 88 relative to the direction of travel 22 of the agricultural machine system (e.g., with respect to the longitudinal axis 82), and the angled portion 88 extends rearwardly and is angled downwardly from the flat portion 86. As used herein with regard to portion(s) of the floor, “flat” refers to a portion that is substantially parallel to the longitudinal axis 82 (e.g., substantially parallel to a plane formed by the longitudinal axis and the lateral axis of the accumulator assembly). Furthermore, as used herein, “substantially parallel” refers to an angular difference (e.g., between the flat portion and the longitudinal axis) of less than a threshold value, such as 3 degrees, 2 degrees, 1 degree, 0.5 degrees, 0.1 degrees, or 0.01 degrees. As illustrated, the angled portion 88 extends downwardly from the flat portion 86 with respect to the vertical axis 84, and the angled portion 88 extends rearwardly from the flat portion 86 relative to the direction of travel 22 (e.g., with respect to the longitudinal axis 82). The slope of the angled portion 88 may be selected to facilitate movement of the agricultural product toward the conveying system, while limiting the extent of the accumulator 24 with respect to the vertical axis 84. The flat portion 86 of the floor 70 enables the capacity of the accumulator 24 to be increased, while maintaining a desired slope of the angled portion 88 of the floor 70 and a desired extent of the accumulator with respect to the vertical axis 84 (e.g., as compared to an accumulator having the desired vertical extent and a floor that only includes an angled portion at the desired slope). The increased capacity of the accumulator 24 may substantially reduce or eliminate the possibility of interrupting the harvesting operation due to overfilling the accumulator.

In the illustrated embodiment, the angled portion 88 of the floor 70 is straight (e.g., linear). However, in other embodiments, the angled portion of the floor may have a curved shape (e.g., concave curved shape or convex curved shape). Furthermore, while the floor 70 of the accumulator 24 has one flat portion 86 and one angled portion 88 in the illustrated embodiment, in other embodiments, the floor of the accumulator may have another suitable configuration. For example, in certain embodiments, the floor of the accumulator may have one or more additional portions, such as an additional flat portion positioned rearward of the angled portion relative to the direction of travel, an additional angled portion, etc. In addition, in certain embodiments, the floor of the accumulator may have a single portion, such as a single flat portion or a single angled portion.

As illustrated, the front wall 74 of the accumulator 24 is substantially parallel to the vertical axis 84 of the accumulator assembly 26 (e.g., substantially parallel to a plane formed by the vertical axis and the lateral axis of the accumulator assembly), and the front wall 74 extends along a substantial portion of a distance 94 between the inlet portion 72 and the floor 70 (e.g., the flat portion 86 of the floor 70). As previously discussed, “substantially parallel” refers to an angular difference (e.g., between the front wall and the vertical axis) of less than a threshold value, such as 3 degrees, 2 degrees, 1 degree, 0.5 degrees, 0.1 degrees, or 0.01 degrees. In addition, as used herein, “substantial portion” refers to a portion (e.g., of the distance between the inlet portion and the floor) greater than a minimum threshold portion, such as 85 percent, 90 percent, 97 percent, or 99 percent. While the front wall 74 is substantially parallel to the vertical axis 84 of the accumulator assembly 26 in the illustrated embodiment, in other embodiments, the front wall may have another suitable configuration (e.g., the front wall may be curved, the front wall may have at least a section that is angled inwardly, the front wall may have at least a section that is angled outwardly, etc.). For example, in certain embodiments, the front wall may extend downwardly and inwardly from the inlet portion to the floor.

In addition, the rear wall 76 of the accumulator 24 extends downwardly and inwardly from the inlet portion 72, such that a bottom 96 of the rear wall 76 is longitudinally aligned with the agitation roller 40. As used herein, “longitudinally aligned” refers to overlap of the longitudinal extents (e.g., of the bottom 96 of the rear wall 76 and the agitation roller 40) with respect to the longitudinal axis 82. In the illustrated embodiment, the rear wall 76 includes an angled portion 98 and a vertical portion 100. The angled portion 98 extends from the inlet portion 72 of the accumulator 24 (e.g., such that the angled portion 98 is angled inwardly at an interface between the rear wall 76 and the inlet portion 72), and the vertical portion 100 extends from the angled portion 98 to the bottom 96 of the rear wall 76. In the illustrated embodiment, the vertical portion 100 is substantially parallel to the vertical axis 84 (e.g., substantially parallel to a plane formed by the vertical axis and the lateral axis of the accumulator assembly). While the angled portion 98 is straight in the illustrated embodiment, in other embodiments, the angled portion may be curved and/or segmented. While the rear wall 76 includes the angled portion 98 extending from the inlet portion 72 and the vertical portion 100 extending from the angled portion 98 in the illustrated embodiment, in other embodiments, the rear wall may have another suitable configuration (e.g., the vertical portion may extend from the inlet portion and the angled portion may extend from the vertical portion, the vertical portion may be omitted, a second vertical portion may be positioned between the inlet portion and the angled portion, etc.). Because the rear wall 76 is angled inwardly from the inlet portion 72 toward the agitation roller 40, the capacity of the accumulator 24 is increased (e.g., as compared to a rear wall that is substantially parallel to the vertical axis and extends between the inlet portion and the agitation roller). As previously discussed, the increased capacity of the accumulator 24 may substantially reduce or eliminate the possibility of interrupting the harvesting operation due to overfilling the accumulator 24. While the rear wall 76 extends downwardly and inwardly from the inlet portion 72 in the illustrated embodiment, in other embodiments, the rear wall may have another suitable configuration (e.g., the rear wall may be substantially parallel to the vertical axis).

Due to the increased capacity of the accumulator 24, the accumulator 24 may have a sufficient capacity to accommodate the agricultural product received from the header during operation of the agricultural machine system. Accordingly, the dimensions of the accumulator 24 are fixed. That is, the accumulator 24 does not include any movable component(s) that enable the accumulator to expand during the harvesting operation. However, in certain embodiments, the accumulator may include at least one movable component configured to move to a position that provides increased accumulator capacity.

In the illustrated embodiment, the accumulator 24 includes the floor 70 having the flat portion 86 and the angled portion 88, the front wall 74 substantially parallel to the vertical axis 84, and the rear wall 76 extending downwardly and inwardly from the inlet portion 72. However, in other embodiments, the accumulator may only include one or two of these features. For example, in certain embodiments, the accumulator may only include one of the floor having the flat portion and the angled portion, the front wall substantially parallel to the vertical axis, or the rear wall extending downwardly and inwardly from the inlet portion.

As illustrated, the accumulator 24 has a maximum longitudinal extent 101 between the front wall 74 (e.g., the inner surface of the front wall 74) and the rear wall 76 (e.g., the inner surface of the rear wall 76) along the longitudinal axis 82, and the accumulator 24 has a maximum vertical extent 103 between a top 105 of the inlet portion 72 (e.g., the inner surface of the top 105 of the inlet portion 72) and the floor 70 (e.g., the inner surface of the floor 70) along the vertical axis 84. In certain embodiments, the ratio of the maximum longitudinal extent 101 to the maximum vertical extent 103 is greater than 0.8:1 (e.g., maximum longitudinal extent : maximum vertical extent > 0.8:1). For example, the ratio of the maximum longitudinal extent 101 to the maximum vertical extent 103 may be greater than 0.85:1, greater than 0.9:1, greater than 1:1, greater than 1.05:1, greater than 1.1:1, greater than 1.15:1, or greater than 1.2:1. By way of further example, the ratio of the maximum longitudinal extent 101 to the maximum vertical extent 103 may be greater than a value between 0.8:1 and 2:1 (e.g., inclusive), between 0.8:1 and 1.5:1 (e.g., inclusive), between 0.8:1 and 1.25:1 (e.g., inclusive), or between 0.8:1 and 1:1 (e.g., inclusive). Because the ratio of the maximum longitudinal extent 101 to the maximum vertical extent 103 is greater than 0.8:1, the maximum vertical extent 103 of the accumulator 24 may be sufficiently reduced to enable the agricultural machine system to be certified for on-road use (e.g., as compared to an accumulator having a smaller maximum longitudinal extent and the same capacity). For example, the reduced maximum vertical extent 103 of the accumulator 24 may enable the maximum height of the agricultural machine system to be less than a regulatory maximum height for passing under on-road overhead obstacles (e.g., power lines, etc.). In addition, the reduced maximum vertical extent 103 of the accumulator may reduce the compaction of the agricultural product at the bottom of the accumulator, thereby facilitating movement of the agricultural product to the conveying system and/or enhancing bale formation. Furthermore, the reduced maximum vertical extent 103 of the accumulator may reduce the pressure applied by the agricultural product to the conveying rollers 66, thereby reducing the power utilized to drive the conveying rollers to rotate. As a result, the efficiency of the agricultural machine system may be increased. In addition, the reduced pressure applied to the conveying rollers 66 may enable the conveying rollers 66 to be driven to rotate faster, thereby increasing the flow rate of the agricultural product to the conveying system. Furthermore, the increased maximum longitudinal extent 101 of the accumulator 24 may enable the speed of the agricultural product to decrease to a lower speed as the agricultural product moves through the inlet portion 72, thereby enhancing the distribution of the agricultural product within the accumulator 24 (e.g., as compared to an accumulator having a smaller maximum longitudinal extent). While the ratio of the maximum longitudinal extent 101 to the maximum vertical extent 103 is greater than 0.8:1 in the embodiments disclosed above, in certain embodiments, the ratio of the maximum longitudinal extent to the maximum vertical extent may be less than or equal to 0.8:1.

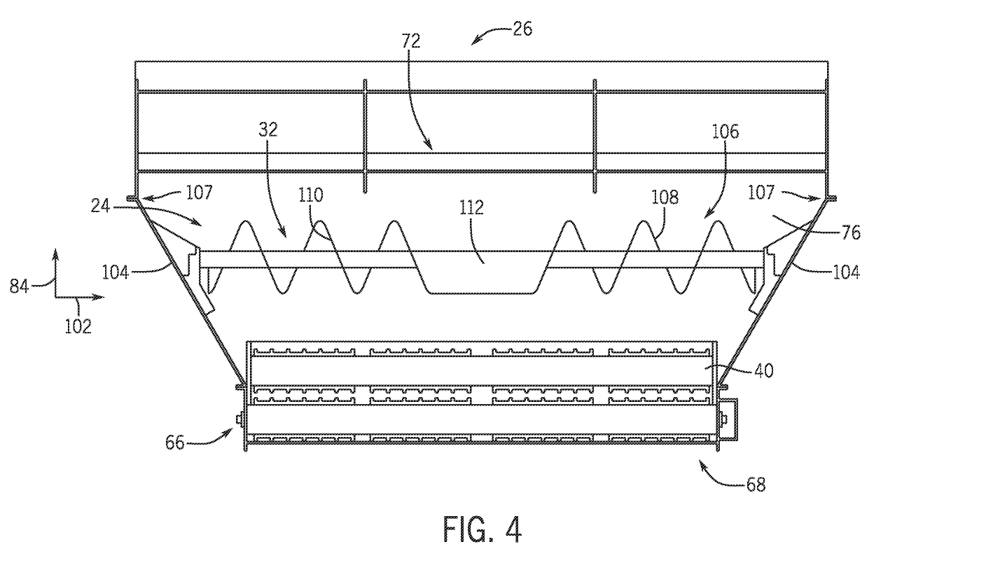

FIG. 4 is a cross-sectional front view of the accumulator assembly 26 of FIG. 3. As illustrated, the single auger 32 is disposed within the accumulator 24 and extends laterally across the accumulator 24 (e.g., with respect to the lateral axis 102 of the accumulator assembly 26). As previously discussed, in certain embodiments, the single auger 32 is the only auger disposed within the accumulator 24. The single auger 32 may be driven to rotate by any suitable drive mechanism(s), such as an electric motor or a hydraulic motor. Furthermore, the single auger 32 may be rotatably coupled to each side wall 104 of the pair of opposing side walls of the accumulator 24 by any suitable joint(s) (e.g., including bearing(s), bushing(s), etc.).

In the illustrated embodiment, each side wall 104 of the pair of opposing side walls extends downwardly and inwardly from the inlet portion 72. Furthermore, each side wall 104 is angled inwardly at an interface 107 between the side wall 104 and the inlet portion 72. For example, in certain embodiments, each side wall includes a single angled portion that extends from the inlet portion to the bottom of the accumulator. Because each side wall 104 is angled inwardly at the interface 107 between the side wall 104 and the inlet portion 72, the accumulator may not include a vertically telescoping portion positioned directly adjacent to the inlet portion (e.g., the dimensions of the accumulator may be fixed). In addition, a side wall having an angled portion that extends from the inlet portion to the bottom of the accumulator may enhance the inward flow of the agricultural product (e.g., as compared to a side wall having a vertical portion extending from the interface between the side wall and the inlet portion). While a side wall having a single angled portion is disclosed above, in certain embodiments, at least one side wall may include at least one vertical portion (e.g., extending downwardly from the angled portion) and/or at least one additional angled portion. In addition, while each side wall 104 extends downwardly an inwardly from the inlet portion 72 in the illustrated embodiment, in other embodiments, at least one side wall may have another suitable configuration (e.g., extending downwardly and outwardly from the inlet portion, substantially parallel to the vertical axis of the accumulator assembly, etc.).

In the illustrated embodiment, the single auger 32 includes a flighting 106 configured to direct the agricultural product toward a center of the accumulator 24 with respect to the lateral axis 102 of the accumulator assembly 26 as the single auger 32 rotates. As illustrated, the flighting 106 includes a first portion 108 having a first pitch configured to direct the agricultural product laterally inwardly, and the flighting 106 includes a second portion 110 having a second pitch, opposite the first pitch, configured to direct the agricultural product laterally inwardly. Furthermore, in the illustrated embodiment, the single auger 32 includes a paddle 112 positioned at a center of the auger 32 with respect to the lateral axis 102 of the accumulator assembly 26. The paddle 112 is configured to drive the agricultural product downwardly with respect to the vertical axis 84 (e.g., to drive the agricultural product toward the conveying rollers 66 during the accumulator unloading process and/or to compact the agricultural product within the accumulator 24 during the accumulator filling process). The combination of the flighting 106 and the paddle 112 controls distribution of the agricultural product within the accumulator 24. While the single auger 32 includes the central paddle 112 in the illustrated embodiment, in other embodiments, the central paddle may be omitted (e.g., the flighting may extend along an entire lateral extent of the single auger), and/or one or more paddles may be positioned at other locations along the lateral extent of the auger. Furthermore, while the flighting 106 of the single auger 32 is configured to direct the agricultural product toward the center of the accumulator 24 with respect to the lateral axis 102 in the illustrated embodiment, in other embodiments, the flighting may be configured to direct the agricultural product in another suitable direction (e.g., laterally outwardly, toward a right side of the accumulator, toward a left side of the accumulator, etc.).

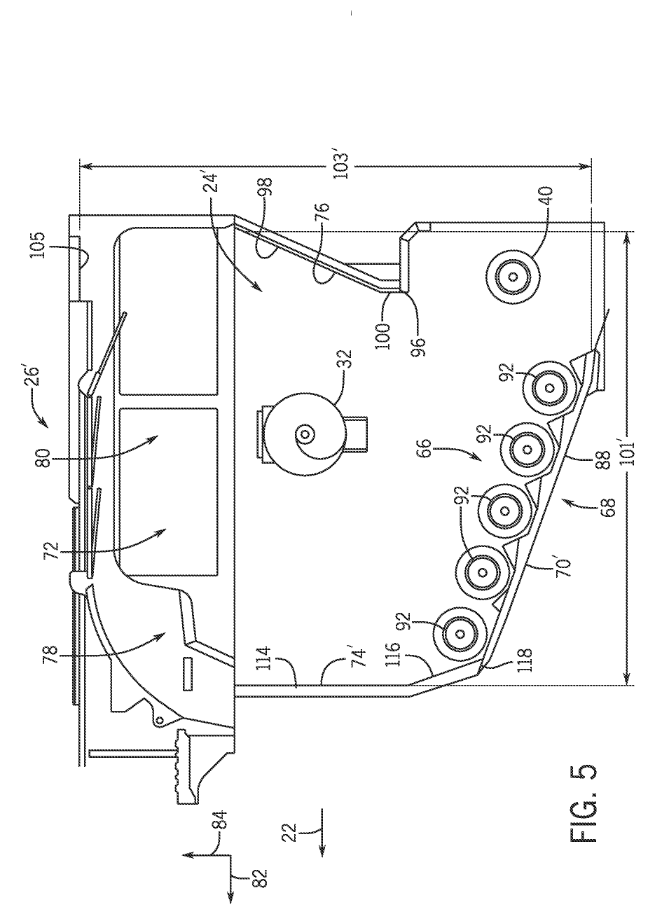

FIG. 5 is a cross-sectional side view of another embodiment of an accumulator assembly 26’ that may be employed within the agricultural product transport assembly of FIG. 2. In the illustrated embodiment, the front wall 74’ of the accumulator 24’ extends downwardly and inwardly from the inlet portion 72. In the illustrated embodiment, the front wall 74’ includes a vertical portion 114 and an angled portion 116. The vertical portion 114 extends from the inlet portion 72 of the accumulator 24’, and the angled portion 116 extends from the vertical portion 114 to a bottom 118 of the front wall 74’ (e.g., at an interface between the front wall 74’ and the floor 70’). In the illustrated embodiment, the vertical portion 114 is substantially parallel to the vertical axis 84 (e.g., substantially parallel to a plane formed by the vertical axis and the lateral axis of the accumulator assembly). While the angled portion 116 is straight in the illustrated embodiment, in other embodiments, the angled portion may be curved and/or segmented. Furthermore, while the front wall 74’ includes the vertical portion 114 extending from the inlet portion 72 and the angled portion 116 extending from the vertical portion 114 in the illustrated embodiment, in other embodiments, the front wall may have another suitable configuration (e.g., the angled portion may extend from the inlet portion and the vertical portion may extend from the angled portion, the vertical portion may be omitted, a second vertical portion may be positioned between the angled portion and the floor, etc.). Because the front wall 74’ is angled downwardly and inwardly from the inlet portion 72, the capacity of the accumulator 24 is increased (e.g., as compared to a front wall that is substantially parallel to the vertical axis and extends between the inlet portion and the termination location of the angled front wall). While the front wall 74’ extends downwardly and inwardly from the inlet portion 72 in the illustrated embodiment, in other embodiments, the front wall may have another suitable configuration (e.g., the front wall may be substantially parallel to the vertical axis).

In the illustrated embodiment, the floor 70’ of the accumulator 24’ only includes an angled portion 88 (e.g., as compared to the flat portion and the angled portion of the floor disclosed above with reference to FIG. 3). Furthermore, all of the conveying rollers 66 (e.g., second conveying rollers 92) are positioned at the angled portion 88 of the floor 70 with respect to the longitudinal axis 82 of the accumulator assembly 26 (e.g., the center of each conveying roller 66 is positioned at the angled portion 88 of the floor 70 with respect to the longitudinal axis 82 of the accumulator assembly 26). In the illustrated embodiment, the accumulator assembly 26’ includes five conveying rollers 66 (e.g., five second conveying rollers 92). As previously discussed, having five or more conveying rollers 66 may enhance flow of the agricultural product through the accumulator toward the conveying system (e.g., as compared to an accumulator assembly having four or fewer conveying rollers). Accordingly, in certain embodiments, the accumulator assembly may include five, six, seven, eight, or more conveying rollers. However, in other embodiments, the accumulator assembly may have four or fewer conveying rollers.

As illustrated, the accumulator 24’ has a maximum longitudinal extent 101’ between the front wall 74’ (e.g., the inner surface of the front wall 74’) and the rear wall 76 (e.g., the inner surface of the rear wall 76) along the longitudinal axis 82, and the accumulator 24’ has a maximum vertical extent 103’ between the top 105 of the inlet portion 72 (e.g., the inner surface of the top 105 of the inlet portion 72) and the floor 70’ (e.g., the inner surface of the floor 70’) along the vertical axis 84. As previously discussed, in certain embodiments, the ratio of the maximum longitudinal extent 101’ to the maximum vertical extent 103’ is greater than 0.8:1 (e.g., maximum longitudinal extent : maximum vertical extent > 0.8:1). For example, the ratio of the maximum longitudinal extent 101’ to the maximum vertical extent 103’ may be greater than 0.85:1, greater than 0.9:1, greater than 1:1, greater than 1.05:1, greater than 1.1:1, greater than 1.15:1, or greater than 1.2:1. By way of further example, the ratio of the maximum longitudinal extent 101’ to the maximum vertical extent 103’ may be greater than a value between 0.8:1 and 2:1 (e.g., inclusive), between 0.8:1 and 1.5:1 (e.g., inclusive), between 0.8:1 and 1.25:1 (e.g., inclusive), or between 0.8:1 and 1:1 (e.g., inclusive). Because the ratio of the maximum longitudinal extent 101’ to the maximum vertical extent 103’ is greater than 0.8:1, the maximum vertical extent 103’ of the accumulator 24’ may be sufficiently reduced to enable the agricultural machine system to be certified for on-road use (e.g., as compared to an accumulator having a smaller maximum longitudinal extent and the same capacity). For example, the reduced maximum vertical extent 103’ of the accumulator 24’ may enable the maximum height of the agricultural machine system to be less than a regulatory maximum height for passing under on-road overhead obstacles (e.g., power lines, etc.). Furthermore, the reduced maximum vertical extent 103’ of the accumulator may reduce the pressure applied by the agricultural product to the conveying rollers 66, thereby reducing the power utilized to drive the conveying rollers to rotate. As a result, the efficiency of the agricultural machine system may be increased. In addition, the reduced pressure applied to the conveying rollers 66 may enable the conveying rollers 66 to be driven to rotate faster, thereby increasing the flow rate of the agricultural product to the conveying system. Furthermore, the increased maximum longitudinal extent 101’ of the accumulator 24 may enable the speed of the agricultural product to decrease to a lower speed as the agricultural product moves through the inlet portion 72, thereby enhancing the distribution of the agricultural product within the accumulator 24’ (e.g., as compared to an accumulator having a smaller maximum longitudinal extent). While the ratio of the maximum longitudinal extent 101’ to the maximum vertical extent 103’ is greater than 0.8:1 in the embodiments disclosed above, in certain embodiments, the ratio of the maximum longitudinal extent to the maximum vertical extent may be less than or equal to 0.8:1.

While the front wall 74’ of the accumulator 24’, the floor 70’ of the accumulator 24’, and the configuration of the conveying rollers 66 are different than the front wall, the floor, and the configuration of the conveying rollers of the accumulator assembly disclosed above with reference to FIG. 3, the remainder of the features, functions, and variations disclosed above with regard to the accumulator assembly of FIG. 3 apply to the illustrated accumulator assembly 26’. For example, in the illustrated embodiment, the dimensions of the accumulator 24’ are fixed, the accumulator assembly 26’ has a single auger 32, the single auger 32 is positioned closer to the rear wall 76 than the front wall 74’ with respect to the longitudinal axis 82, the single auger 32 has a flighting configured to direct the agricultural product toward the center of the accumulator 24’ with respect to the lateral axis, the single auger 32 has a paddle positioned at the center of the auger with respect to the lateral axis, the rear wall 76 extends downwardly and inwardly from the inlet portion 72, such that the bottom 96 of the rear wall 76 is longitudinally aligned with the agitation roller 40. However, in other embodiments, any or all of these features may have any of the variations disclosed above with regard to the accumulator assembly of FIG. 3.

In addition, in certain embodiments, the illustrated accumulator assembly 26’ has the same cross-sectional front view as the accumulator assembly of FIG. 3. Accordingly, in certain embodiments, FIG. 4 is also a cross-sectional front view of the illustrated accumulator assembly 26’. In such embodiments, each side wall of the pair of opposing side walls extends downwardly and inwardly from the inlet portion, the front wall 74’ extends downwardly and inwardly from the inlet portion 72, and the rear wall 76 extends downwardly and inwardly from the inlet portion 72. Because each of the opposing side walls, the front wall, and the rear wall are angled inwardly from the inlet portion 72, the capacity of the accumulator 24’ is increased (e.g., as compared to an accumulator having at least one wall that is substantially parallel to the vertical axis and extends between the inlet portion and the termination location of the respective angled wall). Furthermore, each side wall of the pair of opposing side walls is angled inwardly at the interface between the side wall and the inlet portion. For example, in certain embodiments, each side wall includes an angled portion that extends from the inlet portion to the bottom of the accumulator, which may enhance the inward flow of the agricultural product (e.g., as compared to a side wall having a vertical portion extending from the interface between the side wall and the inlet portion).

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]…” or “step for [perform]ing [a function]…”, it is intended that such elements are to be interpreted under 35 U.S.C. 112(f). However, for any claims containing elements designated in any other manner, it is intended that such elements are not to be interpreted under 35 U.S.C. 112(f).

1. An accumulator assembly for an agricultural harvester, comprising:
an accumulator configured to receive agricultural product from a header of the agricultural harvester via an inlet portion of the accumulator, wherein the accumulator comprises a front wall, a rear wall, and a floor;
at least one auger disposed within the accumulator and extending laterally across the accumulator; and
a plurality of conveying rollers positioned at a bottom of the accumulator, wherein the plurality of conveying rollers is configured to convey the agricultural product toward a conveying system;
wherein a ratio of a maximum longitudinal extent of the accumulator between the front wall and the rear wall along a longitudinal axis of the accumulator assembly to a maximum vertical extent of the accumulator between a top of the inlet portion and the floor along a vertical axis of the accumulator assembly is greater than 0.8:1.

2. The accumulator assembly of claim 1, wherein the floor of the accumulator has a flat portion and an angled portion, the flat portion is positioned forward of the angled portion relative to a direction of travel of the agricultural harvester, the angled portion is angled downwardly from the flat portion, the plurality of conveying rollers comprises at least one first conveying roller positioned at the flat portion of the floor with respect to the longitudinal axis of the accumulator assembly, and the plurality of conveying rollers comprises at least one second conveying roller positioned at the angled portion of the floor with respect to the longitudinal axis of the accumulator assembly.

3. The accumulator assembly of claim 1, wherein the plurality of conveying rollers comprises at least five conveying rollers.

4. The accumulator assembly of claim 1, wherein the at least one auger comprises a single auger, and the single auger is the only auger disposed within the accumulator.

5. The accumulator assembly of claim 3, wherein the single auger is positioned closer to the rear wall of the accumulator than the front wall of the accumulator with respect to the longitudinal axis of the accumulator assembly.

6. The accumulator assembly of claim 1, wherein dimensions of the accumulator are fixed.

7. The accumulator assembly of claim 1, wherein the rear wall of the accumulator extends downwardly and inwardly from the inlet portion, such that a bottom of the rear wall is longitudinally aligned with an agitation roller.

8. The accumulator assembly of claim 1, wherein the accumulator comprises a pair of opposing side walls, each side wall of the pair of opposing side walls extends downwardly and inwardly from the inlet portion, the front wall of the accumulator extends downwardly and inwardly from the inlet portion, and the rear wall of the accumulator extends downwardly and inwardly from the inlet portion.

9. An accumulator assembly for an agricultural harvester, comprising:
an accumulator configured to receive agricultural product from a header of the agricultural harvester via an inlet portion of the accumulator, wherein the accumulator comprises a front wall, a rear wall, a floor, and a pair of opposing side walls;
at least one auger disposed within the accumulator and extending laterally across the accumulator; and
a plurality of conveying rollers positioned at a bottom of the accumulator, wherein the plurality of conveying rollers is configured to convey the agricultural product toward a conveying system;
wherein each side wall of the pair of opposing side walls extends downwardly and inwardly from the inlet portion, the front wall of the accumulator extends downwardly and inwardly from the inlet portion, and the rear wall of the accumulator extends downwardly and inwardly from the inlet portion; and
wherein each side wall of the pair of opposing side walls is angled inwardly at an interface between the side wall and the inlet portion.

10. The accumulator assembly of claim 9, wherein the rear wall of the accumulator extends downwardly and inwardly from the inlet portion, such that a bottom of the rear wall is longitudinally aligned with an agitation roller.

11. The accumulator assembly of claim 9, wherein the at least one auger comprises a single auger, and the single auger is the only auger disposed within the accumulator.

12. The accumulator assembly of claim 11, wherein the single auger is positioned closer to the rear wall of the accumulator than the front wall of the accumulator with respect to a longitudinal axis of the accumulator assembly.

13. The accumulator assembly of claim 9, wherein the at least one auger comprises:
a flighting configured to direct the agricultural product toward a center of the accumulator with respect to a lateral axis of the accumulator assembly; and
a paddle positioned at a center of the at least one auger with respect to the lateral axis of the accumulator assembly.

14. The accumulator assembly of claim 9, wherein dimensions of the accumulator are fixed.

15. An accumulator assembly for an agricultural harvester, comprising:
an accumulator configured to receive agricultural product from a header of the agricultural harvester via an inlet portion of the accumulator;
at least one auger disposed within the accumulator and extending laterally across the accumulator; and
a plurality of conveying rollers positioned at a bottom of the accumulator, wherein the plurality of conveying rollers is configured to convey the agricultural product toward a conveying system;
wherein the accumulator comprises a rear wall extending downwardly and inwardly from the inlet portion, such that a bottom of the rear wall is longitudinally aligned with an agitation roller.

16. The accumulator assembly of claim 15, wherein the accumulator comprises a floor having a flat portion and an angled portion, the flat portion is positioned forward of the angled portion relative to a direction of travel of the agricultural harvester, the angled portion is angled downwardly from the flat portion, the plurality of conveying rollers comprises at least one first conveying roller positioned at the flat portion of the floor with respect to a longitudinal axis of the accumulator assembly, and the plurality of conveying rollers comprises at least one second conveying roller positioned at the angled portion of the floor with respect to the longitudinal axis of the accumulator assembly.

17. The accumulator assembly of claim 15, wherein the at least one auger comprises a single auger, and the single auger is the only auger disposed within the accumulator.

18. The accumulator assembly of claim 17, wherein the single auger is positioned closer to the rear wall of the accumulator than a front wall of the accumulator with respect to a longitudinal axis of the accumulator assembly.

19. The accumulator assembly of claim 15, wherein the plurality of conveying rollers comprises at least five conveying rollers.

20. The accumulator assembly of claim 15, wherein dimensions of the accumulator are fixed.
